(19) United States
(12) Patent Application Publication
(10) Pub. No.: US 2010/0132339 A1
(43) Pub. Date: Jun. 3, 2010

(54) EXHAUST GAS SYSTEM

(76) Inventor: Ralf Barkhage, Lerum (SE)

Correspondence Address: ALSTON & BIRD LLP, BANK OF AMERICA PLAZA, 101 SOUTH TRYON STREET, SUITE 4000, CHARLOTTE, NC, 28280-4000, US

(21) Appl. No.: 12/441,700

(22) PCT Filed: Feb. 28, 2007
(86) PCT No.: PCT/SE07/00185

§ 371 Date: Mar. 17, 2009

(30) Foreign Application Priority Data
Sep. 19, 2006 (SE) PCT/SE2006/001072

(51) Int. Cl. F02D 43/00; F01N 3/023; F01N 1/00; G01F 1/36; G01N 1/22

(52) U.S. Cl. 60/287; 60/295; 60/324; 73/861.42; 73/28.04

(57) ABSTRACT

The invention concerns an exhaust gas system (1) for an internal combustion engine (11), said system (1) comprising an exhaust gas conduit (13), a particulate filter (15) and a controllable exhaust valve (17) arranged in the exhaust gas conduit (13, said exhaust valve (17) being intended for increasing the exhaust gas temperature (TeXh) by increasing an exhaust gas back pressure in situations where the exhaust gas temperature (TeXh) is too low for performing a regeneration process of the particulate filter (15), a temperature measurement means (12) for determining an exhaust gas temperature (TeXh), a first pressure measurement means (14, 14a) for determining an exhaust gas pressure upstream of the valve (17), a control unit (24) for receiving signals from the measurement means (12, 14) and for controlling the valve (17). The invention is characterized in that the system (1) comprises a second pressure measurement means (16, 16a) including a static pressure measurement outlet (16a) positioned, in relation to the valve (17), in such a way that, when exhaust gas flows in a main flow direction (31) in the conduit (13) and the valve (17) is set in a predetermined partly open position (α), a flow velocity of the exhaust gas is considerably higher when passing by the static pressure measurement outlet (16a) compared with the flow velocity upstream of the valve (17). The inventive system provides means for determining whether a regeneration of the filter (15) is required. The invention also concerns methods related to regeneration of a particular filter and a device and method for controlling a fluid flow, such as an exhaust gas flow.

### TECHNICAL FIELD

This invention relates to an exhaust gas system for an internal combustion engine and to methods related to regeneration of a particular filter included in an exhaust gas system. The invention also relates to a device and method for controlling a fluid flow, such as an exhaust gas flow.

### BACKGROUND ART

It is well known to reduce or eliminate particulates in exhaust gas produced from an internal combustion engine by the use of a particulate filter. In particular, diesel engines are prone to produce particulates. Normally, particulates are trapped in a filter that is continuously and/or intermittently regenerated as to avoid clogging of the filter. During the regeneration process, collected carbon-containing particles are combusted.

Generally, particulate filters may or may not make use of a catalytic material that promotes the regeneration process. Such a catalytic material may be provided in the filter or in a unit upstream the filter, or may be supplied to the filter in e.g. liquid form when needed. In filters making use of catalytic material, the collected particles are continuously combusted as long as the exhaust gas temperature is above around 300° C. to 350° C. If catalysts are not used, the filters are intermittently regenerated at a considerably higher regeneration temperature, which temperature is generated by e.g. burning fuel in the filter.

In some situations, such as during low-load engine operation, the exhaust gas temperature becomes lower than the minimum temperature required for continuous catalytic regeneration, i.e. below around 300° C. In such situations, particulates accumulate in the filter and may give rise to the problem of filter clogging. If the exhaust gas temperature is increased sufficiently, the regeneration process will be resumed. However, some particulates on the filter may remain unburned if the amount of accumulated particulates is large. To avoid this, a relatively long time period may be needed for completing the combustion.

Furthermore, it is known that the carbon-containing particulates deposited on the filter gradually become less apt to burn. As incombustible particulates cover the oxidation catalyst, it becomes difficult to burn carbon-containing particulates on the filter. Since the collected particulates cannot be appropriately processed, the filter becomes clogged in some cases.

Various ways of increasing the exhaust gas temperature as to reach a sufficient regeneration temperature, i.e. as to achieve an active or forced regeneration of the filter, have been presented in the past.

EP1229223 and EP1662101 disclose systems where the exhaust gas temperature is increased using delayed fuel injection. US2005/0148430 discloses a method where the temperature is increased by increasing the engine load by e.g. activating the brakes of a vehicle.

Some proposed systems make use of a valve arranged in the exhaust pipe as to increase the back pressure, and thus the temperature, of the exhaust gas in order to perform a forced regeneration. U.S. Pat. No. 6,381,952 and U.S. Pat. No. 6,966,179 disclose systems using a combination of fuel injection and such an exhaust valve. EP260031 discloses a system where the exhaust valve is activated depending on a measured pressure drop over the filter combined with mapped engine data of the particular engine used. During the regeneration mode, the valve is controlled using e.g. the exhaust gas temperature (together with fuel input control) or the back pressure (together with engine mapping for obtaining what pressure is needed) as the controlling parameter. DE19838032 discloses a system wherein e.g. exhaust gas pressure and temperature are measured to determine whether the exhaust valve should be set in either of two positions; an open, normal position and an almost closed position, wherein the latter position is kept during a predetermined time period.

Regeneration of a filter should be carried out sufficiently often to avoid high pressure drops and possibly damage of the filter. On the other hand, regeneration should not be carried out without cause since all types of regeneration processes are fuel consuming. It is therefore important to have adequate means for determining when a (forced) regeneration is needed, in addition to the means required for carrying out the actual (forced) regeneration process.

None of the proposed systems or methods for initiating and performing forced filter regeneration appears to be fully satisfying. Further, methods adapted to one system are generally difficult to apply to another system.

### DISCLOSURE OF INVENTION

The object of this invention is to provide equipment and methods for forced filter regeneration that exhibit improved functionality compared to conventional means and that also are more generally applicable. Another object is to provide a device and method for controlling a fluid flow, such as an exhaust gas flow. These objects are achieved by the system, device and methods defined by the technical features contained in the independent claims 1, 7, 18, 20, 23 and 25. The dependent claims contain advantageous embodiments, further developments and variants of the invention.

The invention concerns an exhaust gas system for an internal combustion engine, said system comprising an exhaust gas conduit, a particulate filter and a controllable exhaust valve arranged in the exhaust gas conduit, said exhaust valve being intended for increasing the exhaust gas temperature by increasing an exhaust gas back pressure in situations where the exhaust gas temperature is too low for performing a regeneration process of the particulate filter, the system further comprising a temperature measurement means for determining an exhaust gas temperature, a first pressure measurement means for determining an exhaust gas pressure upstream of the valve, and a control unit for receiving signals from the measurement means and for controlling the valve.

The inventive system comprises a second pressure measurement means including a static pressure measurement outlet positioned, in relation to the valve, in such a way that, when exhaust gas flows in a main flow direction in the conduit and the valve is set in a predetermined partly open position, a flow velocity of the exhaust gas is considerably higher when passing by the static pressure measurement outlet compared with the flow velocity upstream of the valve. In other words, the static pressure measurement outlet is positioned such that the valve, together with the first and second pressure measurement means, can be combined to form a flow measuring device with a function similar to e.g. a venturi tube. With this flow measuring device, it is possible to determine the exhaust gas mass flow and thereby the volume flow, which, in combination with a pressure drop over the filter, makes it possible to determine a degree of filter soot loading, i.e. whether regeneration is required. In the inventive system the valve is thus not only used for increasing the exhaust gas temperature, it is also used for flow measurements.

An advantageous effect of the inventive system is that it enables determination of the exhaust gas volume flow and the need for performing a forced regeneration process without having to map the engine and exhaust systems which is an expensive procedure. A further advantage of the inventive system is that no auxiliary equipment for flow measurements is required. A still further advantage of the inventive system is that it is easy to apply to a variety of different engine and exhaust systems since it can be installed in an existing system and since it is not required to establish a communication with a particular engine control system.

In an advantageous embodiment of the inventive system the valve comprises a rotatably mounted valve disc that can be set in different angular positions in relation to the main flow direction of the exhaust gas. Preferably, the static pressure measurement outlet is positioned at a distance downstream of the valve disc at a side of the conduit facing a rear, downstream edge of the disc when the disc is set in the predetermined partly open position. Preferably, said distance is less than a width of the valve disc, wherein said width relates to a direction perpendicular to both the main flow direction and to an axis of rotation of the valve disc. More preferably, the distance is adapted to position the static pressure measurement outlet such as to be in-between i) alongside of the rear, downstream edge of the disc, seen in a longitudinal direction of the exhaust gas conduit, and ii) a position corresponding to an imaginary extension of the disc, when the disc is set in the predetermined partly open position. Preferably, the static pressure measurement outlet is arranged in a housing of the valve. Such a design has a good function, makes the production cost-effective and allows a conventional butterfly valve to be used.

The invention also concerns a fluid flow control device, comprising an area regulating member movably arranged in a fluid flow conduit, said member being arranged to influence an opening area of the fluid flow conduit when moved between different positions. The inventive control device is characterized in that it further comprises a static pressure measurement outlet positioned, in relation to the area regulating member, in such a way that, when a fluid flows in a main flow direction in the conduit and the area regulating member is set in a predetermined partly open position, a flow velocity of the fluid is considerably higher when passing by the pressure outlet compared with the flow velocity upstream of the area regulating member.

Such a fluid flow control device can be used to measure a mass or volume flow of a gas or liquid flowing in a conduit and to regulate the opening area of such a conduit. Compared to conventional devices for measuring mass or volume flow of a fluid, such as venturi tubes etc., the inventive device has the advantages that it is resistant to a rough environment and is adaptable to different flows owing to its variable opening area, i.e. the variable opening position of the area regulating member. In addition, the inventive fluid flow control device can make use of a part that might be needed anyway, i.e. the area regulating member, for the purpose of determining a fluid flow parameter. Thus, less additional parts are required for the measurement.

In an advantageous embodiment of the inventive fluid flow control device, the area regulating member is a rotatably mounted plate that can be set in different angular positions in relation to the main flow direction of the fluid. Preferably, the pressure measurement outlet is positioned at a distance downstream of the rotatably mounted plate at a side of the flow conduit facing a rear, downstream edge of the plate when the plate is set in the predetermined partly open position. Preferably, said distance is less than a width of the rotatably mounted plate, wherein said width relates to a direction perpendicular to both the main flow direction and to an axis of rotation of the rotatably mounted plate. More preferably, the distance is adapted to position the static pressure measurement outlet such as to be in-between i) alongside of the rear, downstream edge of the plate, seen in a longitudinal direction of the conduit, and ii) a position corresponding to an imaginary extension of the plate, when the plate is set in a predetermined partly open position. Preferably, the control device comprises a housing defining the fluid flow conduit wherein the static pressure measurement outlet is arranged in the housing. The static pressure measurements outlet is preferably directed substantially perpendicular to a main flow direction of the fluid. Preferably, the area regulating member and the static pressure measurement outlet are arranged in a common unit. Preferably, the inventive device comprises a further pressure measurement outlet positioned upstream of the area regulating member.

The invention also concerns a method for determining a fluid mass flow or volume flow in a fluid low conduit using a fluid flow control device of the abovementioned type. This method comprises the steps of setting the area regulating member in the predetermined partly open position, measuring a static fluid pressure at the static pressure measurement outlet, determining a ratio between a total absolute fluid pressure upstream of the area regulating member and a static absolute fluid pressure obtained from said pressure measurement at the static pressure measurement outlet, and calculating a fluid mass or volume flow based on said determined fluid pressures. A step of measuring a total fluid pressure at a further pressure measurement outlet positioned upstream of the area regulating member may also be included in the inventive method.

The invention also concerns a method for monitoring a status of a particulate filter arranged in an exhaust gas flow conduit associated with an internal combustion engine, such as a diesel engine. This method is characterized in that it comprises the steps of continually collecting data on a temperature of the exhaust gas entering the filter, comparing the collected data with a regeneration temperature required for achieving regeneration in the filter, determining a total regeneration time period during which the filter has been subject to regeneration, determining a total time period for the data collection, determining a ratio between the total regeneration time period and the total time period.

The inventive filter status monitoring method has the advantageous effect that it provides an indication on whether it is likely that the filter needs to be regenerated. A further advantage is that the method is relatively simple, it collects and calculates data but does not interfere with the processes going on in the exhaust gas system, which makes it possible to let the method run continuously and to apply the method to most systems. The inventive monitoring method may be used as a manual or automatic trigger for initiating a more thorough filter status controlling method or for initiating a regeneration process. Moreover, the inventive monitoring method is useful for controlling a forced regeneration process where it can be used to estimate the time required for completing the regeneration.

In an advantageous embodiment of the inventive filter status monitoring method it further comprises the step of adjusting the total regeneration time period such as to take into account that a rate of regeneration increases with temperature. This way it is possible to obtain a more accurate indication on the filter status. Preferably, the adjusted total regeneration time period is calculated using the following expression:

$${t}_{regen} = {\sum }_{n = 1}^{n} {( S O R \cdot Δ t )}_{n}$$

where Δt is a time period and where SOR forms a model for calculating the soot regeneration rate in the filter.

The invention also concerns a method for determining a degree of soot loading of a particulate filter arranged in an exhaust gas flow conduit associated with an internal combustion engine, such as a diesel engine, wherein an exhaust valve is arranged in the exhaust gas flow conduit. This method is characterized in that it comprises the steps of: setting the exhaust valve in a first predetermined, partly open position such that the flow velocity of the exhaust gas flowing through the valve is significantly increased; determining an exhaust gas temperature, a pressure drop over the filter, and a ratio between a total absolute exhaust gas pressure upstream of the valve and a static absolute exhaust gas pressure of the exhaust gas flowing through the valve; calculating an exhaust gas volume flow; calculating a soot constant, corresponding to a certain degree of soot loading, from the measured pressure drop and the calculated exhaust gas volume flow.

The inventive filter soot loading determination method has the advantageous effect that it, based on actual measurements, provides information on whether the filter needs to be regenerated. As mentioned above in relation to the inventive system, an advantage of this principle is that costly mapping of the engine and exhaust systems is not necessary. A further advantage of the inventive method of determining the filter soot loading is that no auxiliary equipment for flow measurements is required. A still further advantage is that the method is easy to apply to a variety of different engine and exhaust systems since only minor modifications of an existing system is necessary and since it is not required to establish a communication with a particular engine control system.

In an advantageous embodiment of the inventive filter soot loading determination method it further comprises the steps of determining whether the first predetermined position generates a too high back pressure, and, if that is the case, setting the exhaust valve in a second predetermined, partly open position that forms a larger opening area than the first predetermined position. This makes the method more flexible such that it can be run also when the operation conditions of the engine differ from normal or expected conditions.

The invention also concerns a method for performing a forced regeneration process of a particulate filter arranged in an exhaust gas system of an internal combustion engine, said method comprising the step of increasing an exhaust gas temperature by activating an exhaust valve arranged in the exhaust gas system This method is characterized in that it comprises the steps of calculating a required total exhaust gas pressure upstream the valve corresponding to a target exhaust gas temperature to be reached, and regulating the exhaust gas pressure by varying an opening position of the exhaust valve using the calculated required total exhaust gas pressure as desired value and a pressure as measured by a first pressure sensor positioned upstream of the valve as actual value.

The inventive regeneration method has the advantageous effect that it uses the pressure as control parameter which makes the control method very direct, fast and reliable. Using this method it is possible to avoid using e.g. the valve position as control parameter which is less direct and also requires thorough calibration. A further advantage is that it is possible to avoid expensive engine mapping, which anyway leads to a less direct controlling method.

In an advantageous embodiment of the inventive regeneration method it further comprises the steps of calculating a contribution from the engine to the exhaust gas temperature, determining whether measured temperature variations can be attributed to variations in engine operation, and adjusting the exhaust valve as to compensate for the contribution from the engine. This improves the process of regulating the pressure.

In an advantageous embodiment of the system or methods described above the filter is adapted to a continuous regeneration technique, i.e. a technique normally involving the use of a catalytic material. Such a filter requires a lower regeneration temperature for which the system and methods described are well suited.

### BRIEF DESCRIPTION OF DRAWINGS

In the description of the invention given below reference is made to the following figure, in which:

FIG. 1 shows, in a schematic view, a preferred embodiment of an exhaust gas system according to the invention,

FIG. 2 shows a preferred embodiment of a fluid flow control device according to the invention, which device forms a part of the system in FIG. 1,

FIG. 3 shows, in a principal view, how a degree of filter soot loading is obtained from determined volume flow and pressure drop according to the invention,

FIG. 4 shows the main steps of a preferred embodiment of an inventive method for determining a degree of soot loading of a particulate filter, and

FIG. 5 shows the main steps of a preferred embodiment of an inventive method for performing a forced regeneration process of a filter.

### EMBODIMENT(S) OF THE INVENTION

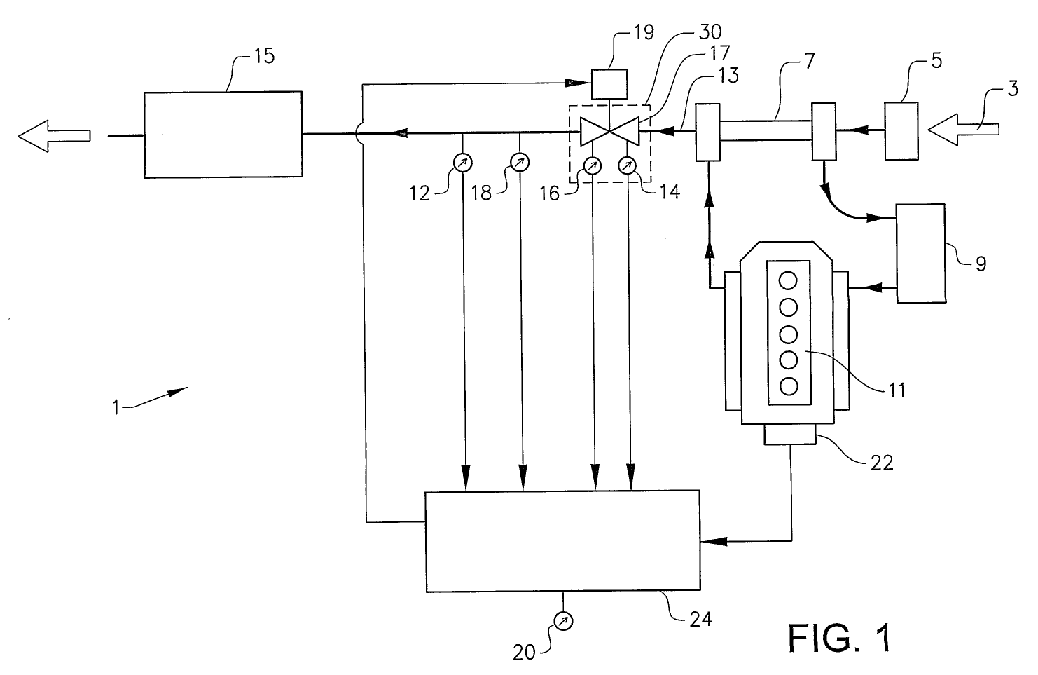

FIG. 1 shows, in a schematic view, an exhaust gas system 1 for treatment of an exhaust gas flow from an internal combustion engine according to a preferred embodiment of the invention. Air 3 passes an air filter 5, a turbo unit 7 and a cooler 9 on its way to a diesel engine 11. Exhaust gas leaving the engine 11 passes the turbo unit 7 and enters an exhaust gas conduit 13 whereby it passes a particulate filter 15 before it leaves the system. A gas flow control device 30, comprising an exhaust butterfly valve 17, is positioned in the exhaust gas conduit 13 upstream the filter 15. A valve operating actuator 19 is arranged to operate, i.e. to open and close, the exhaust valve 17.

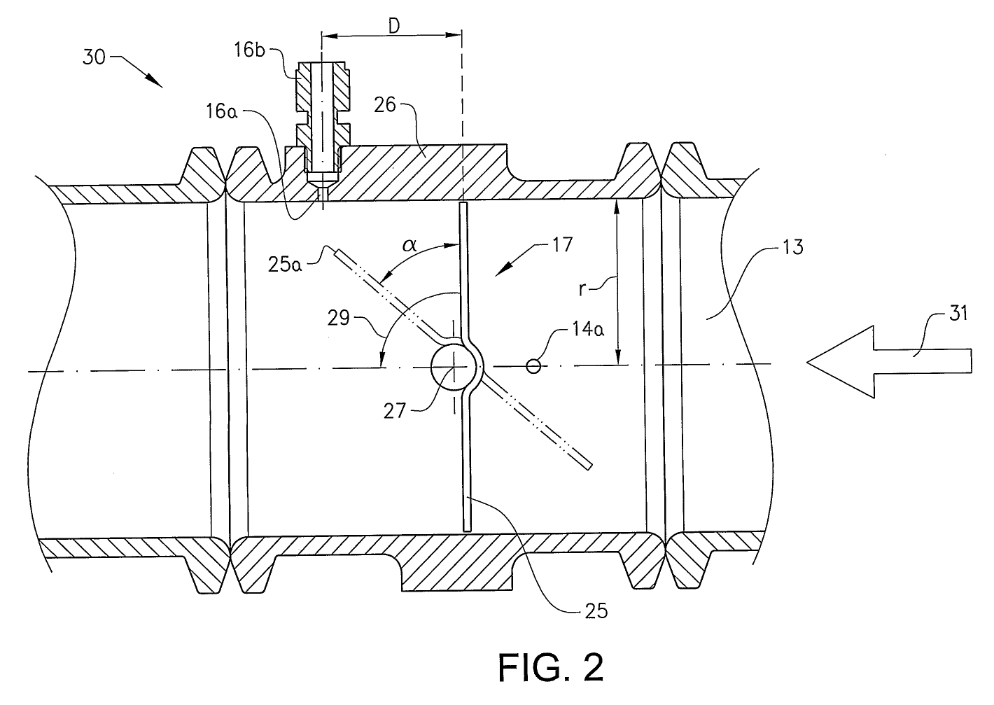

A first and a second pressure sensor 14, 16 are arranged in connection to the exhaust valve 17. These pressure sensors are further described with reference to FIG. 2. A temperature sensor 12 and a third pressure sensor 18 are arranged in the exhaust gas conduit 13 between the filter 15 and the exhaust valve 17, i.e. upstream the filter 15 and downstream the valve 17. A fourth pressure sensor 20, arranged to measure the barometric pressure, is fitted inside a control unit 24. An engine speed sensor 22 is arranged on the engine 11.

The control unit 24, comprising a microcomputer, software etc., is arranged to receive data from the sensors 12, 14, 16, 18, 20, 22. Further, the gas flow controlling device 30 comprises finite position sensors (not shown) sending information to the control unit 24 regarding an opening position of the exhaust valve 17. The control unit 24 controls the gas flow controlling device 30, i.e. it controls the opening position of the exhaust valve 17, via the valve actuator 19. The controlling process is further described below.

An engine control system (EDC: Electronic Diesel Control) may be connected to the engine 11 as to receive engine data, such as air intake temperature and pressure, engine speed and load demand, and to control e.g. the engine fuel supply. In the example shown in FIG. 1, the engine speed sensor 22 shown does not form part of the EDC. Instead, the engine speed sensor 22 is a separate sensor that forms part of the inventive system 1. Normally, the EDC includes its own, original, engine speed sensor.

The particulate filter 15 is in this case an integrated exhaust gas after-treatment unit comprising a catalytic oxidation unit for oxidation of CO (carbon monoxide) and HC (hydrocarbons), arranged in series with a catalytically coated monolith for filtering the exhaust gas particulates. Thus, the filter 15 is in this case adapted to a continuous regeneration technique. The catalytic coating on the monolith reduces the required exhaust gas temperature for converting the collected particulates from about 600° C. in the absence of a catalyst to around 300-350° C. Such filters and oxidation devices are per se well known for a person skilled in the art.

A personal computer can be connected to the control unit 24 for communication, i.e. updating calculation models, adjusting the control system to a particular application, etc. Remote connection to the control unit 24 can be achieved using e.g. a mobile phone system.

FIG. 2 shows a detailed view of an inventive fluid flow control device 30, in this case a gas flow control device, comprising the exhaust valve 17. The valve 17 is arranged in a valve housing 26 that forms a part of the exhaust gas conduit 13, which in the example shown has a circular cross section with a diameter of 80 mm. An area regulating member in the form of a circular valve disc 25 is arranged onto a valve axis in the form of a rotatable rod 27. The disc 25 is thoroughly centered in the exhaust gas conduit 13 with a sufficient clearance between the disc 25 and the valve housing 26. The disc 25 can be rotated in the range 0-90° around the rod 27 as indicated by a first arrow 29. A second arrow 31 indicates the main direction of the exhaust gas flow. At 0° the disc 25 is positioned perpendicular to the flow direction 31 and is thus fully closed. At 90° the disc 25 is positioned parallel to the flow direction 31 and is thus fully open. The rod 27, and thereby the valve disc 25, is controlled by the valve actuator 19 (not shown in FIG. 2), which in turn is controlled by the control unit 24.

A first pressure measurement outlet 14a connected to the first pressure sensor 14 is arranged straight in front of the rotatable rod 27, i.e. upstream the valve 17 when the device 30 is in operation. The distance between the rod 27 and the first pressure outlet 14a should be sufficient to avoid vortex effects and to avoid that the disc 25 covers the outlet 14a at only a small opening angle. In this example the distance from the rod 27 should be at least 4-5 mm.

A second pressure measurement outlet 16a connected to the second pressure sensor 16 is arranged at a backside of the valve 17, i.e. downstream the valve 17 when the device 30 is in operation. The second pressure outlet 16a is positioned a distance D downstream of the valve disc 25, with reference to a closed position of the valve disc 25. Roughly, the distance D corresponds to the distance (as seen along a longitudinal axis of the conduit 13 in the main direction 31 of the exhaust gas flow) between the second pressure outlet 16a and a center of the rotatable rod 27. In this case the distance D is 34 mm. FIG. 2 also shows a connecting member 16b threaded onto the second pressure outlet 16a.

Each pressure sensor outlet 14a, 16a has the form of a through hole in the valve housing 26 and is directed towards a center of the conduit 13, i.e. each outlet 14a, 16a is directed substantially perpendicular to the main flow direction 31.

The position of the second pressure outlet 16a relative to the valve disc 25 is adapted such as to enable accurate measurements of the static pressure of a gas flowing through the valve 17 when the valve 17 is partly open. In such measurements the gas flow controlling device 30, including the valve 17, thus has a flow measuring function. To perform such measurements, the valve disc 25 is set in a predefined position corresponding to a certain predetermined opening angle α, which angle α is sufficiently small for forming a gas conduit opening area that in turn is sufficiently small for generating a sufficiently high flow velocity, and which angle α at the same time is sufficiently large for avoiding a generation of a too large back pressure for the engine 11. The distance D is adapted to position the second pressure outlet 16a such as to be approximately alongside of, seen in a longitudinal direction of the exhaust gas conduit 13, a rear (downstream) edge 25a of the valve disc 25 when the disc 25 is positioned in this angle α. This way, the second pressure outlet 16a is located where the flow velocity is at, or close to, its maximum and thus where the static pressure is at, or close to, its minimum. In this particular case, the angle α is 45°. The second pressure sensor 16, when connected to its corresponding outlet 16a, will thus measure the static pressure of the gas when it flows through, or somewhat downstream of, the valve 17.

To obtain the absolute static pressure the second pressure sensor 16 may be an absolute pressure sensor. Alternatively, the measured pressure can be compared with the pressure measured by the fourth pressure sensor 20 or with an estimated barometric pressure. The same applies to the first pressure sensor 14.

Denoting a radius of the valve disc 25 “r”, it can be derived that the second pressure outlet 16a is positioned alongside of the edge 25a of the valve disc 25 if the distance D=r·sin α, and thus that D=r·0.71 if α=45°. In some applications it may be advantageous to place the second pressure outlet 16a somewhat further away from the valve disc 25, i.e. slightly downstream of the edge 25a when the valve disc 25 is positioned in the angle α. For instance, the second pressure outlet 16a can be arranged in the valve housing 26 at a position corresponding to an imaginary extension of the valve disc 25. Such a position corresponds to D=r ·tan α, from which it follows that D=r if α=45°. In the example shown D=34/40·r=0.85·r which means that the second pressure outlet 16a is positioned in between “alongside of the edge 25a” and “corresponding to an imaginary extension of the valve disc 25”. In order to make the measurement of the static pressure useful with the type of valve shown in FIG. 2, the length of the distance D should be less than around 2·r and the angle α should be less than around 65°. It should be noted that a sufficiently accurate measurement may be obtained also when the actual valve angle used differs somewhat from the predetermined optimum angle α. The predetermined optimum angle α and the distance D can be tested out or calculated for a particular application.

The third pressure sensor 18 is arranged in a similar way as the first and second pressure sensors, i.e. its pressure outlet forms an opening in a wall of the conduit 13. Pressure sensors arranged in this way measures the static pressure of the flowing fluid. However, the velocity of the exhaust gas in the conduit 13 is normally so low that the static pressure measured can be considered to represent the total pressure. An exception to this is where the valve 17 is used to increase the flow velocity such that the static pressure (measured by the second pressure sensor 16) differs considerably from the total pressure (measured by the first pressure sensor 14).

The pressure sensors 14, 16, 18, 20 included in the system measure the exhaust gas pressure in the exhaust gas conduit 13 in the following way: the first pressure sensor 14 measures the total pressure upstream, and in this example relatively close to, the valve 17; the second pressure sensor 16 measures the static pressure at the valve 17 (which pressure is influenced by the position of the valve disc 25); the third pressure sensor 18 measures the total pressure between the filter 15 and the valve 17, i.e. upstream the filter 15 and downstream the valve 17; and the fourth pressure sensor 20 measures the ambient air pressure.

The combination of the valve 17 and the second pressure sensor 16 forms a gas flow control device 30 that can be used in a regulating mode, wherein the gas flow is controlled by varying the position of the valve disc 25, or in a measuring mode, wherein the static pressure of the gas flowing through the valve 17 is measured by setting the valve disc 25 in a certain position. By measuring also the total pressure, preferably by using the first pressure sensor 14, a mass and volume flow of the exhaust gas can be calculated (in similarity with the principles of a venturi tube).

In principle, conventional pressure sensors and valve parts can be used to form the inventive gas flow control device 30.

A main function of the gas flow control device 30 in this application is to use the exhaust valve 17 to vary the exhaust gas back pressure so as to increase, and keep, the exhaust gas temperature above the required level for regeneration of the particulate filter in situations where the exhaust gas temperature is too low, e.g. at low engine load. As described above, the opening area of the valve 17 can be controlled between 0-100% (excluding the circular clearance area). Another main function of the gas flow control device 30 is that it is used in calculations of the exhaust gas volume flow.

A main function of the control unit 24 is to control the exhaust valve 17, and thus the exhaust gas back pressure, in order to control the exhaust gas temperature. The actual backpressure and temperature are given by the first pressure sensor 14 and temperature sensor 12. The control unit 24 calculates a backpressure that corresponds to a predefined temperature that in turn corresponds to the required regeneration temperature given by the filter specification. The control system 24 is then tuning the valve 17 until the backpressure is at the calculated level by sending a pulse width modulated signal to the valve actuator 19.

The inventive concept concerns several methods for operating the inventive system including a method for monitoring a soot loading status of the filter 15 involving continuous recording of temperature data and calculation of a regeneration factor (RF); a method for determining a degree of soot loading (SL %) of the filter 15 using a measured pressure drop Δp over the filter 15 together with an exhaust gas volume flow V_{f} calculated from measurements of the pressure and temperature of the exhaust gas; and a method for performing a forced regeneration process of the filter 15. The inventive concept also concerns a method for fluid flow measurements.

The term “forced” or “active” regeneration is used to denote a regeneration process where the valve 17 is used to increase the exhaust gas temperature. If the exhaust gas temperature is sufficiently high for the regeneration process to take place without having to activate the valve 17, the regeneration process is denoted “spontaneous”.

In the following, the inventive method of monitoring the filter status will be described. When the engine is running, an actual temperature of the exhaust gas Tₑₓₕ flowing into the filter 15 is measured continuously by the temperature sensor 12. This temperature, together with the time, is recorded by the control unit 24 at a constant sampling frequency. A suitable sampling frequency for this is 0.25-1 Hz. A number of data points, each of which includes an exhaust gas temperature Tₑₓₕ and a corresponding time period Δt, are thus collected by the control unit 24. At a particular sampling occasion the exhaust gas temperature Tₑₓₕ may or may not have been above a required regeneration temperature T_{regen} given for the particular filter used. Above T_{regen} spontaneous regeneration occurs in the filter 15. Whether a small or a large fraction of the data points have been above T_{regen} depends to a large deal on the load history of the engine 11.

Each data point is processed in the control unit 24 to determine if the filter 15 was in a regeneration mode or in a soot accumulation mode at the time of sampling. Data acquired in this process are used to calculate an accumulated regeneration time period during which spontaneous regeneration has been taken place in the filter 15, i.e during which the temperature has been sufficient for the regeneration process, and to calculate an accumulated total time period tₜₒₜₐₗ. Since the rate of regeneration is temperature dependent (it increases with increasing temperature), the regeneration time period is re-calculated depending on the temperature history into an adjusted (fictive) time period t_{regen} that takes the temperature effects into account. In most cases, the adjusted t_{regen} will be longer than the actual, true regeneration time period.

By forming a ratio between the adjusted (fictive) t_{regen} and the total time period tₜₒₜₐₗ, an estimated, statistically based measure is formed of the status of the filter 15. This measure is denoted regeneration factor RF. The control unit 24 calculates the RF. If the RF is low, say below 10%, it is likely that the filter 15 needs to be regenerated. By comparing the calculated RF with a predetermined reference value, it is thus possible to use the RF to determine whether a forced regeneration process is likely to be needed. The RF can be used as a direct trigger for starting a forced regeneration. However, the RF is preferably used to start another process in which the degree of soot loading is determined by more direct measurements. This process is further described below. In any case, the calculated RF is preferably used for information and/or estimation purposes. Moreover, the RF is useful for controlling the forced regeneration process where it can be used to estimate the time required for completing the regeneration.

The extension of the regeneration time period to the adjusted (fictive) total regeneration time period T_{regen} is done using a factor denoted SOR (Soot Oxidation Rate). The t_{regen} is calculated using the expression

$${t}_{regen} = {\sum }_{n = 1}^{n} {( S O R \cdot Δ t )}_{n} \qquad ( 1 )$$

where Δt is a time period, e.g. the inverse of the sampling frequency if all data points are used, and where SOR is calculated from the expression

$$S O R = {( \frac{{T}_{exh}}{{T}_{regen}} )}^{{K}_{SOR}} \qquad ( 2 )$$

where Tₑₓₕ is the actual exhaust gas temperature, T_{regen} is the specified regeneration temperature for the filter used, and Kₛₒᵣ is a constant selected depending on the filter used. Kₛₒᵣ accounts for different combustion rates in different types of filters. Kₛₒᵣ as such is known to the person skilled in the art.

A condition used is that if the calculated value of SOR≦1 for a certain time period Δt, then SOR is set to zero for that particular time period in the calculation of t_{regen}. If the calculated value of SOR>1, then this calculated value is used.

SOR thus forms a model for calculating the soot regeneration rate in the particular type of filter used.

The regeneration factor (RF) is then finally given by

$$R F = \frac{{t}_{regen}}{{t}_{total}} \qquad ( 3 )$$

where tₜₒₜₐₗ is the total, real time elapsed from a reference point of time. The regeneration factor RF is a measure of how long time (fictive time) the filter 15 has been subject to regeneration compared to the total time (real time).

The above described method for monitoring a soot loading status of the filter 15 can be summarized as follows:
collecting data of the exhaust gas temperature Tₑₓₕ
comparing the collected data with a regeneration temperature T_{regen} required for achieving regeneration in the filter 15
determining a total regeneration time period during which regeneration has been taken place in the filter 15
determining an adjusted total regeneration time period t_{regen} that takes into account that a rate of regeneration increases with temperature (using equations 1 and 2)
determining a total time period tₜₒₜₐₗ for the data collection
determining a regeneration factor RF by comparing t_{regen} and tₜₒₜₐₗ (using equation 3)
comparing the regeneration factor RF with a predetermined reference value.

When a preliminary need for filter regeneration has been indicated by the monitoring method, i.e. by the regeneration factor RF, the actual need for starting a forced regeneration process is determined by determining the actual degree of soot loading.

In the following, the method for determining the degree of soot loading (SF %) of the filter 15 will be described. This method involves measuring the pressure drop Δp over the filter 15 and calculating the exhaust gas volume flow V_{f} from an exhaust gas mass flow m_{f} obtained from pressure and temperature measurements. The pressure drop Δp is obtained from the pressures measured by the third and the fourth pressure sensors 18, 20 (or solely by the third pressure sensor 18 assuming a normal barometric pressure).

In order to obtain the exhaust gas volume flow V_{f}, the exhaust valve 17 is set into a certain position, as described in relation to FIG. 2, whereby the first pressure sensor 14 measures the total exhaust gas pressure in front of (upstream) the valve 17 and the second pressure sensor 16 measures the static pressure of the exhaust gas flowing through the valve 17. On the basis of these pressure measurements, the control unit 24 calculates first the mass flow m_{f} and then the volume flow V_{f} of the exhaust gas. To determine the degree of soot loading SL %, the control unit 24 compares a relation between the pressure drop Δp and the volume flow V_{f} with a predefined table. The obtained value of the degree of soot loading SL % can be compared to a predefined value and used to automatically initiate a forced regeneration process. The obtained value can also be displayed to an operator of the system, such as a vehicle driver. The system may be arranged so that the operator manually initiates the forced regeneration.

In order to calculate the exhaust gas volume flow V_{f}, the exhaust valve 17, the temperature sensor 12 and the first and second pressure sensors 14, 16 are used. A further parameter is an opening area A of the valve 17 at (a) certain fixed open position(s). The calculation model described below forms a sub-routine that can be used by other calculation models or processes included in the control unit 24.

The mass flow of exhaust gas through the valve 17 is given by

$${m}_{f} = \frac{{C}_{D} \cdot A \cdot {p}_{14}}{\sqrt{R \cdot {T}_{exh}}} \cdot {( \frac{{p}_{16}}{{p}_{14}} )}^{\frac{1}{γ}} \cdot \sqrt{\frac{2 \cdot γ}{γ - 1} \cdot [ 1 - {( \frac{{p}_{16 }}{{p}_{14}} )}^{\frac{γ - 1}{γ}} ]} \qquad ( 4 )$$

or (see below)

$${m}_{f} = \frac{{C}_{D} \cdot A \cdot {p}_{14}}{\sqrt{R \cdot {T}_{exh}}} \cdot \sqrt{γ} \cdot {( \frac{2}{γ + 1} )}^{\frac{γ + 1}{2 ( γ - 1 )}} \qquad ( 5 )$$

where

C_{D}=a−b·α+c·α² (6)

and where the symbols used are described in table 1.

TABLE 1

| Symbol | Unit | Description | Source |
|---|---|---|---|
| A | m² | Valve opening area | Calculated |
| m_{f} | Kg/s | Exhaust gas mass flow | Calculated |
| V_{f} | m³/s | Exhaust gas volume flow | Calculated |
| P₁₄ | Pa | Total absolute pressure | Sensor 14 |
| | | upstream of valve | |
| P₁₆ | Pa | Static absolute pressure | Sensor 16 |
| | | at valve | |
| R | J/kg K | Gas constant | Fixed value |
| Tₑₓₕ | Kelvin | Exhaust gas temperature | Sensor 12 |
| Γ | | Isentropic exponent | Table |
| A | Degrees | Valve opening angle | Sensor |
| C_{D} | | Flow coefficient | Calculated |

C_{D} is a ratio between actual flow and a theoretical (friction free) flow. In this case C_{D} has been determined experimentally for a number of different valve opening 25 angles α whereby a function C_{D}=f(α) has been derived. The constants a, b and c depend on the valve geometry and should not be changed for a given system. It is a matter of routine measurements to obtain an expression for C_{D} that is valid for a particular valve type or size or for a particular application.

The isentropic exponent γ is a well known parameter denoting the ratio Cₚ/Cᵥ. For diesel engine exhaust gas, this ratio is close to 1.33.

Before calculating the mass flow m_{f} it is checked whether the flow is choked, i.e. whether the flow is sonic. This is carried out using the expression

$$\frac{{p}_{16}}{{p}_{14}} \leq 0 , 54 \qquad ( 7 )$$

Thus, if the ratio p₁₆/p₁₄ is less or equal to 0.54 the flow is considered to be choked and in such a case the shorter equation 5 is used for calculating the mass flow m_{f}. Consequently, if this ratio is more than 0.54 equation 4 is used for calculating the mass flow m_{f}.

In the next step, the mass flow m_{f} is used to calculate a volume flow V_{f} through the filter 15 using the expression

$${V}_{f} = \frac{{m}_{f} \cdot R \cdot {T}_{exh}}{{p}_{18}} \qquad ( 8 )$$

where p₁₈ is the pressure measured by the third pressure sensor 18.

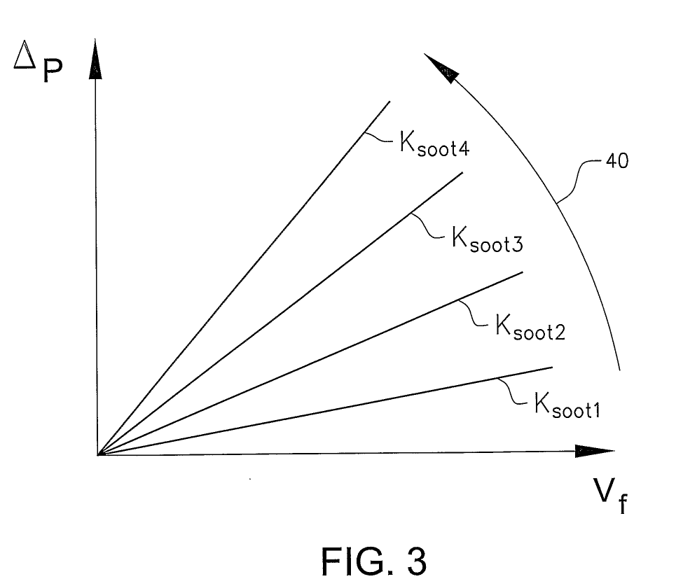

In the next step, a “soot constant” kₛₒₒₜ is calculated using the expression

$${k}_{soot} = \frac{Δ p}{{V}_{f}} \qquad ( 9 )$$

where Δp is the pressure drop (in Pascal) over the filter 15 and where V_{f} is the calculated volume flow (in m³/s). A certain value of kₛₒₒₜ corresponds to a certain degree of soot loading SL % which can be expressed as a percentage of a filter containing a maximum amount of particulates, i.e. where 0% means that the filter 15 is clean and 100% means that the filter 15 contains a maximum (allowed) amount of trapped particulates. As can be seen from equation 9, kₛₒₒₜ forms a value of the slope of a line in a chart showing the pressure drop Δp over the filter 15 as a function of the volume flow V_{f}, Lines with different slopes in such a chart thus correspond to different values of kₛₒₒₜ, and thus to different degrees of soot loading SL %. A principal illustration of this is shown in FIG. 3 where an arrow 40 indicates increasing kₛₒₒₜ. In the calculations, SL % is obtained from a predefined converting table adapted to the particular filter used.

The equations 4-9 are in principal known to a person skilled in the art. A fundamental principle of the invention is the realization that the valve 17 can be used in an advantageous way to increase the flow velocity such that the static absolute pressure p₁₆ of the gas flowing through the valve 17 can be determined, and thereby making it possible to use equations 4-9.

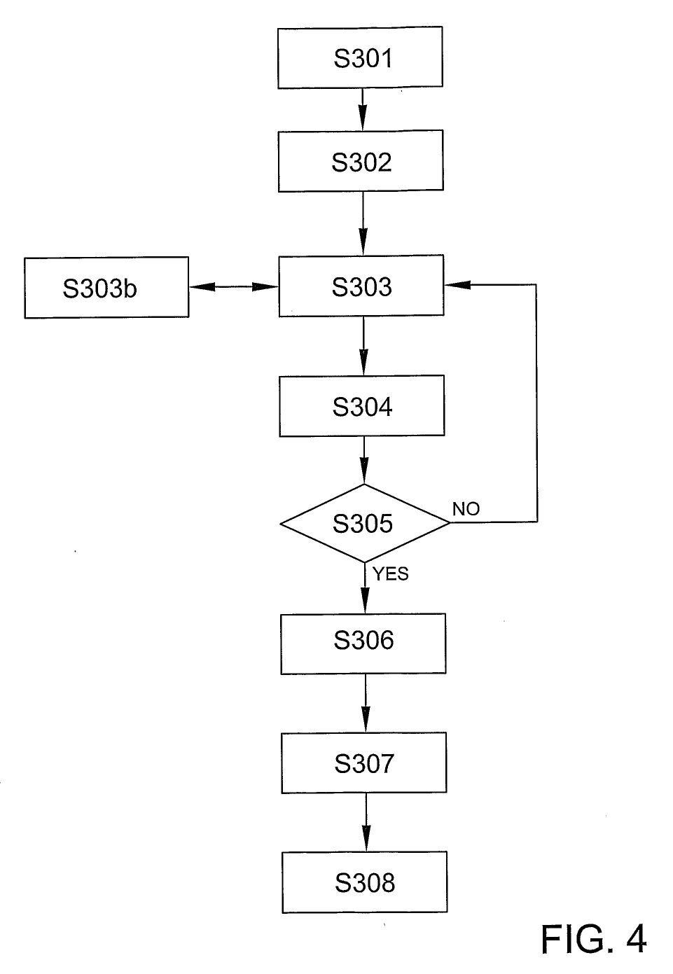

The main steps of the method for determining the soot loading degree SL % from a measured pressure drop Δp and a calculated volume flow V_{f} are shown in FIG. 4.

In step 301 the method for determining the soot loading degree SL % is initiated. Initiation is triggered by the method for calculating RF as described above. Initiation may also be based on a measurement of a time period that has elapsed since a certain event, such as since the last determination of the soot loading degree SL % or since the last thorough regeneration process was performed, which could be either a successful forced regeneration or a sufficiently long spontaneous regeneration. Initiation could be triggered when this measured time period equals a predetermined maximum time period.

Step 302 refers to checking of starting conditions, for instance that engine speed and exhaust gas temperature are within allowed ranges.

In step 303 the valve 17, i.e. the valve disc 25, is set in a certain predetermined opening angle α that defines a certain predetermined opening area A_{α}. In this example, α is 45° leading to an opening area that is reduced to around 10% of the opening area when the valve 17 is fully open (where the reduced opening area is seen as the area as projected in a plane perpendicular to the main flow direction).

In step 304 the signals from the temperature sensor 12; the pressure sensors 14, 16, 18, 20; and the engine speed sensor 22 are read by the control unit 24.

In step 305 it is checked whether the safety conditions are fulfilled regarding pressure, temperature and engine speed. If, in step 305, it is determined that the exhaust gas back pressure is too high, i.e. if the current engine operation mode is such that the valve angle α generates a too high backpressure, step 303 is re-run with a second predetermined opening angle β that defines a second predetermined opening area A_{β}, where β is greater than α such that A_{β} becomes greater than A_{α}. This step is denoted S303b in FIG. 4. In this example β is 50°. If also the angle β creates a too high back pressure, step 303 is re-run an additional time with a third predetermined angle defining a further increased opening area. If also this third angle is unsuitable with regard to the back pressure, a certain time period is allowed to lapse before the method starts again in step 302.

In step 306 the exhaust gas mass flow m_{f} and volume flow V_{f} are calculated using equations 4-8.

In step 307 kₛₒₒₜ is calculated using equation 9. In addition, the calculated kₛₒₒₜ is converted to a corresponding soot loading percentage SL %.

In step 308 an output soot loading percentage SL % is compared with a reference value as to, if greater than the reference value, initiate the forced regeneration process. The output soot loading percentage SL % can also be displayed to a user of the system, such as a driver of a vehicle equipped with the inventive system 1. For example, the SL % can be displayed in the following way: if SL %<50% then a green diode is switched on; if 50%≦SL %≦80% then a green-yellow diode is switched on; if 80%<SL %≦90% then a yellow diode is switched on; and if 90%<SL %≦100% then a red diode is switched on. Further, output soot loading percentage SL % is stored in the control unit 24.

In the following, the inventive method of controlling the exhaust gas temperature will be described more in detail. A basic feature is that the exhaust gas temperature can be increased by using a valve that increases the exhaust gas back pressure. In the inventive method, the control unit 24 is adapted to calculate the pressure needed for reaching a predefined temperature sufficient for carrying out regeneration of the filter 15. When the temperature increases above the temperature produced by the engine itself, the control unit 24 also calculates the contribution from the engine 11 to the exhaust gas temperature in order to determine whether measured temperature variations can be attributed to variations in engine load. If so, the control unit 24 adjusts the valve 17 to adjust the exhaust gas pressure as to compensate for the contribution from the engine 11, for example it opens the valve 17 slightly if the engine load increases slightly. This procedure will go on continually at a frequency of about 1-3 Hz in order to pick up changes in exhaust temperature that are generated by changes in engine load and/or speed. The reason for not regulating directly on the temperature is that temperature variation is a too slow process. To use the pressure as an input controlling parameter is better because pressure variation is a much faster process corresponding to the timescale of variations generated by an internal combustion engine.

The models in the control unit 24 have also built in possibilities for adjusting the calculations to different engine sizes and types of application, which makes it possible to fine tune the control down to an individual engine.

To calculate the required total exhaust gas pressure p_{stryp} upstream the valve 17, i.e. where the first pressure sensor 14 is located, corresponding to the target exhaust gas temperature to be reached, the following formula is used:

$${p}_{stryp} = \frac{{T}_{regen} - {T}_{unreg}}{{R}_{p}} , \qquad ( 10 )$$

where T_{regen} is the specified regeneration temperature given for the filter used, T_{unreg} is a calculated engine exhaust gas temperature which would be the resulting temperature if the valve 17 would have been kept in a fully open position, given by the expression

$${T}_{unreg} = \frac{{T}_{exh} - {K}_{0} \cdot {p}_{14}}{1 + {k}_{p} \cdot {p}_{14}} , \qquad ( 11 )$$

where Tₑₓₕ is the actual exhaust gas temperature obtained by the temperature sensor 12, and

Rₚ=K₀+kₚ·T_{unreg} (12), where

p₁₄ is the pressure obtained by the first pressure sensor 14 upstream the valve 17, and where K₀ and kₚ are constants that depend on type of application and engine. In the described example, the values used are K₀=−300 and kₚ=1.4 (with pressure expressed in bar and temperature in ° C.).

Some other parameters are used for restricting or interrupting regulation of the exhaust valve 17. Regulating is allowed only in a certain engine speed range between limiting lower and higher engine speed values (RPMₘᵢₙ-RPMₘₐₓ). There is also a limiting maximum value for the exhaust gas pressure pₘₐₓ as measured by the first pressure sensor 14. Further, the regulation is not allowed to start if the temperature as measured by the temperature sensor 12 is below a minimum value Tₘᵢₙ. If any of the restricting parameters falls outside the allowable range, the forced regeneration process is interrupted and the valve 17 is set in a fully open position. If the conditions change so that the restricting parameter falls within their respective allowable range, the regeneration resumes.

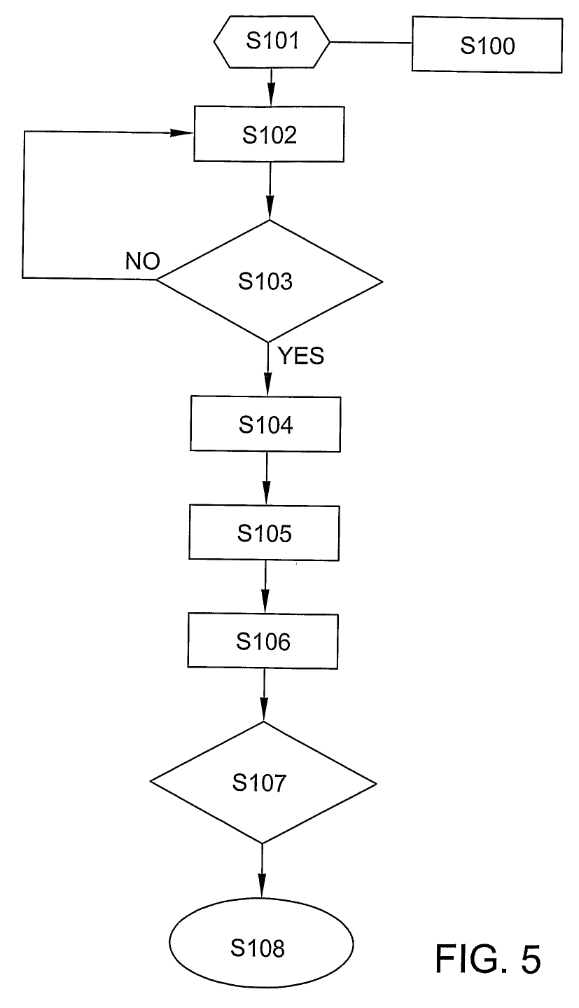

FIG. 5 shows a flowchart of a preferred embodiment of the method of controlling the exhaust gas temperature.

In step 101, the forced regeneration process is initiated. Whether the regeneration process should be initiated is decided in a proceeding step, S100, wherein the decision to initiate regeneration is triggered by the method for determining the degree of soot loading SL % (which method in turn is triggered by the method for determining the regeneration factor RF).

In step 102, signals from the temperature sensor 12, the engine speed sensor 22 and the first pressure sensor 14 are monitored by the control unit 24.

In step 103, a comparison is made whether the measured temperature is greater than the minimum temperature Tₘᵢₙ. If the answer is no, step 102 is repeated. If the answer is yes, the method proceeds to step 104.

In step 104, Rₚ is calculated using equation (12).

In step 105, T_{unreg} is calculated using equation (11).

In step 106, p_{stryp} is calculated using equation (10).

In step 107, the calculated value of p_{stryp} is checked such that:
if p_{stryp}>pₘₐₓ, then p_{stryp} is set equal to pₘₐₓ,
if p_{stryp}<0, then p_{stryp} is set to zero or a minimum value, and
if the engine speed is less than RPMₘᵢₙ or greater than RPMₘₐₓ, then p_{stryp} is set to zero.

In step 108, the exhaust gas pressure is regulated by varying the opening position of the exhaust valve 17 using the calculated p_{stryp} as desired value and the pressure p₁₄ as measured by the first pressure sensor 14 as actual value.

In a further step, conditions for interrupting the regeneration process are checked. This step involves checking whether the forced regeneration has continued at least for a minimum time period tₘᵢₙ but no longer than a maximum time period tₘₐₓ, and whether the regeneration factor RF has reached above a predetermined minimum limit RFₘᵢₙ. The step of checking the interruption conditions runs in parallel with steps 101-108.

If tₘᵢₙ<t<tₘₐₓ and RF<RFₘᵢₙ, then the regeneration is allowed to continue. The method for determining the regeneration factor RF, including logging of temperature and time data, is continued and the new data are added to the old data. If tₘᵢₙ<t<tₘₐₓ and RF>RFₘᵢₙ, or, if t>tₘₐₓ, then the regeneration process is interrupted. At this point, the method for determining the degree of soot loading is run to check whether the filter 15 really is sufficiently clean. If this is the case, the regeneration process is considered to be completed and the calculations of RF are reset. If this is not the case, the calculations of RF are still reset but the regeneration process is resumed. Also the time is reset so that the resumed process runs for at least tₘᵢₙ.

A main program controls management of the entire system. This includes switching between the different filter system control methods as well as handling the communication interface with the user and storing of information for maintenance. For instance, the main program keeps track of when to call the right procedure, process or step depending on present and historical information.

Normally, a forced regeneration process will only be initiated if the exhaust gas temperature is below the required regeneration temperature. However, a forced regeneration may be initiated even if the temperature already is above the required temperature in order to further increase the temperature and thereby further increase the regeneration rate.

To summarize, the described invention concerns a way to increase the exhaust gas temperature to a level where regeneration of accumulated soot takes place in the filter. Furthermore, the invention comprises methods for monitoring and surveying the complete system such as the continuous calculation of the soot status of the filter as well as the determined degree of soot loading in the filter. Besides this, the inventive system also collects and stores statistical information and data for maintenance and for continuously informing the user/operator/driver.

The invention is not limited by the embodiments described above but can be modified in various ways within the scope of the claims. For instance, instead of using one pressure sensor for each pressure outlet, a differential pressure sensor can be connected to two pressure outlets. As an example, the third pressure sensor 18 could be a differential pressure sensor that measures the pressure drop Δp over the filter directly. Also the first and second pressure sensors 14, 16 can be substituted by a differential pressure sensor (provided that the pressure ratio p₁₆/p₁₄ still can be obtained). Moreover, the fourth pressure sensor 20 may alternatively be placed in the exhaust gas conduit 13 downstream of the filter 15. However, it is a simpler and less costly solution to fit it inside the control unit 24. The barometric sensor 20 is optional in that a normal air pressure can be assumed or estimated. However, the calculations become more accurate using an actual barometric pressure. It may be noted that, regarding pressure sensors, it is not necessary that the actual sensors are located in close connection with the (hot) exhaust gas conduit 13, only the pressure outlets.

Furthermore, a signal from an engine speed sensor of an EDC may be used in the inventive system instead of the separate sensor 24. Also other EDC data may be used if available.

The temperature sensor 12 monitoring the exhaust gas temperature could alternatively be placed upstream the exhaust valve 17.

A wide band lambda sensor may be included in the system 1 to avoid situations where large amounts of soot are produced by the engine due to a too high back pressure. Such a lambda sensor can be used to limit the maximum allowed back pressure during regulation of the valve 17.

Further, it is possible to determine the SL %, i.e. to determine the V_{f} from e.g. pressure measurements, also during an on-going forced regeneration process by frequently re-calculating the varying opening area of the valve 17.

The fluid flow controlling device 30 can be used also in other engine types and other applications where a flow of gas or liquid is to be controlled. Compared to conventional devices for measuring mass or volume flow of a fluid, such as venturi tubes etc., the inventive device 30 has the advantages that it is resistant to a rough environment and is adaptable to different flows owing to its variable opening area, i.e. the variable opening position of the valve disc 25. In addition, the inventive gas flow control device 30 can, as described above, use an already needed part, i.e. the valve 17, for the purpose of determining the volume flow V_{f} of the exhaust gas. Thus, less additional parts are required for the measurement. Preferably, the dimension of the valve housing 26 is similar to the gas conduit 13 it should be applied to. Thereby, it becomes easy to install the gas flow control device 30 in an existing system.

Preferably, the first and second pressure outlets 14a, 16a, together with the area regulating member 25, are included in the fluid flow control device 30 which then forms one single measuring/regulating ready-to-use unit that easily can be installed in an existing system. Alternatively, it is possible to arrange the pressure outlets 14a, 16a and the area regulating member 25 in two or three different parts, such as pipe portions, which parts are connected to a common housing 26 as to form the fluid flow control device 30.

The flow conduit 13 and the area regulating member 25 do not necessarily need to have a circular cross section, instead they could have e.g. a rectangular cross section. In such a case the radius r of the valve disc 25 corresponds to half of the width of a rectangular disc or plate, as seen in a direction perpendicular to an axis of rotation of the plate. Thus, the total width of such a disc/plate in that direction becomes 2·r. If this plate or disc is mounted to a rotatable rod 27, as exemplified in FIG. 2, the axis of rotation of the plate or disc can be said to correspond to the rotatable rod 27. It may be noted that the rotatable rod 27 does not necessarily have to extend across the flow conduit 13; the rod can for instance be made up of two shorter rod portions attached to opposite sides of the plate or disc.

The formulas presented above form examples of suitable formulas but may be modified to suit different conditions.

1-26. (canceled)

27. An exhaust gas system for an internal combustion engine comprising:
an exhaust gas conduit;
a particulate filter;
a controllable exhaust valve arranged within the exhaust gas conduit and configured for increasing an exhaust gas temperature by increasing an exhaust gas back pressure when the exhaust gas temperature is too low for performing a regeneration process of the particulate filter;
a temperature measurement means for determining the exhaust gas temperature;
a first pressure measurement means for determining an exhaust gas pressure upstream of the controllable exhaust valve;
a control unit configured for receiving signals from the temperature measurement means and the first pressure measurement means and for controlling the controllable exhaust valve; and
a second pressure measurement means including a static pressure measurement outlet positioned, in relation to the controllable exhaust valve, in such a way that, when exhaust gas flows in a main flow direction in the exhaust gas conduit and the controllable exhaust valve is set in a predetermined partly open position, the flow velocity of the exhaust gas is higher when passing by the static pressure measurement outlet than the flow velocity of the exhaust gas when upstream of the controllable exhaust valve.

28. The exhaust gas system of claim 27, wherein the controllable exhaust valve comprises a rotatably mounted valve disc that can be set in different angular positions in relation to the main flow direction of the exhaust gas.

29. The exhaust gas system of claim 28, wherein the static pressure measurement outlet is positioned at a distance downstream of the rotatably mounted valve disc at a side of the exhaust gas conduit facing a rear, downstream edge of the rotatably mounted valve disc when the rotatably mounted valve disc is set in the predetermined partly open position.

30. The exhaust gas system of claim 29, wherein the static pressure measurement outlet is positioned at a distance downstream of the rotatably mounted valve disc that is less than a width of the rotatably mounted valve disc, and wherein the width relates to a direction perpendicular to both the main flow direction of the exhaust gas and to an axis of rotation of the rotatably mounted valve disc.

31. The exhaust gas system of claim 29, wherein the static pressure measurement outlet is positioned at a distance downstream of the rotatably mounted valve disc such that the static pressure measurement outlet is in-between i) a position alongside of the rear, downstream edge of the rotatably mounted valve disc, seen in a longitudinal direction of the exhaust gas conduit, and ii) a position corresponding to an imaginary extension of the rotatably mounted valve disc, when the rotatably mounted valve disc is set in the predetermined partly open position.

32. The exhaust gas system of claim 27, wherein the static pressure measurement outlet is arranged in a housing of the controllable exhaust valve.

33. A fluid flow control device, comprising:
an area regulating member movably arranged in a fluid flow conduit and arranged to influence an opening area of the fluid flow conduit when moved between different positions; and
a static pressure measurement outlet positioned, in relation to the area regulating member, in such a way that, when a fluid flows in a main flow direction in the fluid flow conduit and the area regulating member is set in a predetermined partly open position, a flow velocity of the fluid is higher when passing by the static measurement pressure outlet than the flow velocity of the fluid upstream of the area regulating member.

34. The fluid flow control device of claim 33, wherein the area regulating member is a rotatably mounted plate that can be set in different angular positions in relation to the main flow direction of the fluid.

35. The fluid flow control device of claim 34, wherein the static pressure measurement outlet is positioned at a distance downstream of the rotatably mounted plate at a side of the fluid flow conduit facing a rear, downstream edge of the rotatably mounted plate when the rotatably mounted plate is set in the predetermined partly open position.

36. The fluid flow control device of claim 35, wherein the distance downstream of the rotatably mounted plate is less than a width of the rotatably mounted plate, wherein said width relates to a direction perpendicular to both the main flow direction and to an axis of rotation of the rotatably mounted plate.

37. The fluid flow control device of claim 35, wherein the static pressure measurement outlet is positioned at a distance downstream of the rotatably mounted plate such that the static pressure measurement outlet is in-between i) a position alongside of the rear, downstream edge of the rotatably mounted plate, seen in a longitudinal direction of the fluid flow conduit, and ii) a position corresponding to an imaginary extension of the rotatably mounted plate, when the rotatably mounted plate is set in the predetermined partly open position.

38. The fluid flow control device of claim 33, further comprising a housing defining the fluid flow conduit, wherein the static pressure measurement outlet is arranged within the housing.

39. The fluid flow control device of claim 33, wherein the static pressure measurement outlet is directed substantially perpendicular to the main flow direction of the fluid.

40. The fluid flow control device of claim 33, wherein the area regulating member and the static pressure measurement outlet are arranged in a common unit.

41. The fluid flow control device of claim 33, further comprising a pressure sensor connected to the static pressure measurement outlet.

42. The fluid flow control device of claim 33, further comprising a total pressure measurement outlet positioned upstream of the area regulating member.

43. The fluid flow control device of claim 33, wherein the fluid flow control device is arranged in an exhaust gas system of a combustion engine.

44. A method for determining a fluid mass flow or volume flow in a fluid flow conduit comprising the steps of:
setting an area regulating member movably arranged in a fluid flow conduit to a predetermined partly open position with a control unit comprising a microcomputer, wherein the area regulating member is a rotatably mounted plate that can be set in different angular positions in relation to the main flow direction of the fluid, the different angular positions of the area regulating member influencing an opening area of the fluid flow conduit;
measuring a static fluid pressure with a second pressure sensor at a static pressure measurement outlet positioned, in relation to the area regulating member, in such a way that, when a fluid flows in a main flow direction in the fluid flow conduit and the area regulating member is set in a predetermined partly open position, the flow velocity of the fluid is considerably higher when passing by the static measurement pressure outlet than the flow velocity of the fluid velocity upstream of the area regulating member;
determining by the control unit a ratio between a total absolute fluid pressure upstream of the area regulating member and the measured static absolute fluid pressure obtained from said pressure measurement at the static pressure measurement outlet; and
calculating by the control unit a fluid mass or volume flow based on the total absolute fluid pressure and the measured static absolute fluid pressure.

45. The method of claim 44, further comprising the step of:
measuring a total absolute fluid pressure with a first pressure sensor positioned upstream of the area regulating member.

46. A method for monitoring a status of a particulate filter arranged in an exhaust gas flow conduit associated with an internal combustion engine comprising the steps of:
continuously measuring the temperature of exhaust gas entering the particulate filter with a first temperature sensor at a certain frequency for a certain period of time;
determining by a control unit comprising a microcomputer whether exhaust gas temperature measurements made by the first temperature sensor are above or below a regeneration temperature required for achieving regeneration in the particulate filter;
determining by the control unit a total regeneration time period during which the particulate filter has been subject to regeneration;
determining by the control unit a total time period during which temperature measurements were taken; and
determining by the control unit a ratio between the total regeneration time period and the total time period.

47. The method of claim 46, further comprising the step of adjusting the total regeneration time period to take into account varying rates of regeneration according to temperature.

48. The method of claim 47, wherein the total regeneration time period is calculated by the control unit using the following expression:
$${t}_{regen} = {\sum }_{n = 1}^{n} {( S O R \cdot Δ t )}_{n}$$
where Δt is a time period and where SOR forms a model for calculating the soot regeneration rate in the particulate filter.

49. A method for determining a degree of soot loading of a particulate filter comprising the steps of:
setting an exhaust valve arranged in an exhaust gas flow conduit associated with an internal combustion engine in a first predetermined, partly open position with a control unit comprising a microcomputer controlling the position of the exhaust valve, the partly open position of the exhaust valve causing the flow velocity of the exhaust gas flowing through the exhaust valve to increase,
determining an exhaust gas temperature by measuring the exhaust gas temperature with a temperature sensor;
measuring the total absolute pressure of the exhaust gas with a total pressure sensor positioned between the exhaust valve and a particulate filter connected to the exhaust gas flow conduit;
measuring the ambient air pressure with an ambient pressure sensor;
determining by the control unit the pressure drop over the particulate filter using the downstream total absolute pressure measurement and the ambient air pressure measurement;
determining by the control unit a ratio between a total absolute exhaust gas pressure upstream of the exhaust valve and a static absolute exhaust gas pressure of the exhaust gas flowing through the exhaust valve by measuring the total absolute pressure of the exhaust gas with a first pressure sensor positioned upstream of the exhaust valve, measuring the static absolute exhaust gas pressure with a second pressure sensor, and determining the ratio between the total absolute exhaust gas pressure and the static absolute pressure using the upstream total absolute pressure measurement and the static absolute pressure measurement,
calculating by the control unit an exhaust gas volume flow; and
calculating by the control unit a soot constant, corresponding to a certain degree of soot loading, from the measured pressure drop and the calculated exhaust gas volume flow.

50. The method of claim 49, further comprising the steps of:
determining by the control unit whether the first predetermined position generates an undesirable level of back pressure; and, if so,
setting by the control unit the exhaust valve in a second predetermined, partly open position that forms a larger opening area than the first predetermined position.

51. A method for performing a forced regeneration process of a particulate filter comprising the steps of:
increasing an exhaust gas temperature by rotating an exhaust valve arranged in the exhaust gas system of an internal combustion engine to a partially closed position with a control unit comprising a microcomputer;
calculating by the control unit a required total exhaust gas pressure upstream the exhaust valve corresponding to a target exhaust gas temperature related to the forced regeneration process; and
regulating the exhaust gas pressure by varying an opening position of the exhaust valve with the control unit using the calculated required total exhaust gas pressure as a desired value and a pressure measurement made by a first pressure sensor positioned upstream of the exhaust valve as an actual value.

52. The method of claim 51, further comprising the steps of:
calculating a contribution from the engine to the exhaust gas temperature with the control unit;
determining whether measured temperature variations can be attributed to variations in engine operation with the control unit; and
adjusting the exhaust valve as to compensate for the contribution from the internal combustion engine with the control unit.

53. The method of claim 46, further comprising the step of generating by the control unit, based on the calculated ratio between the total regeneration time period and the total time period, a control signal triggering a forced regeneration process of the particulate filter.

54. The method of claim 46, further comprising the step of generating by the control unit, based on the calculated ratio between the total regeneration time period and the total time period, a control signal initiating a process of determining a degree of soot loading of the particular filter.

55. The method of claim 49, further comprising the step of generating by the control unit, based on the calculated degree of soot loading, a control signal adjusting the position of the exhaust valve to begin a forced regeneration process of the particulate filter.
